(19) United States
(12) Patent Application Publication
(10) Pub. No.: US 2012/0327632 A1
(43) Pub. Date: Dec. 27, 2012

(54) BOTTOM CHASSIS FOR TABLET TYPE MOBILE DISPLAY AND METHOD FOR MANUFACTURING THE BOTTOM CHASSIS

(75) Inventors: Sang-Joon PARK, Hwaseong-si (KR); Bo-Hyun HEO, Ansan-si (KR)

(73) Assignees: SAMSUNG ELECTRONICS CO., LTD, Suwon-si (KR); G&G CORPORATION, Cheonan-si (KR)

(21) Appl. No.: 13/227,015

(22) Filed: Sep. 7, 2011

(30) Foreign Application Priority Data
Jun. 27, 2011 (KR) 10-2001-0062522

(51) Int. Cl. G09F 13/04; B21B 27/06

(52) U.S. Cl. 362/97.1; 72/200

(57) ABSTRACT

Bottom chassis for a tablet-type mobile display having a thickness of 0.2 mm, light weight and high strength by controlling the alloy composition and process condition.

A method for manufacturing the bottom chassis comprises:
(a) homogenizing a slab material by heating, the slab material having at most 0.3 wt % silicone, at most 0.4 wt % iron, at most 0.1 wt % copper, 0.15˜0.2 wt % manganese, 2.5˜3.5 wt % magnesium, 0.15˜0.35 wt % chromium, and at most 0.1 wt % zinc, the balance being impurities and aluminum;
(b) subjecting the homogenized material to hot-rolling to thickness of 7.5±0.5 mm followed by cooling;
(c) subjecting the hot-rolled and cooled material to a 1^{st} cold-rolling to thickness of 2.5±0.5 mm followed by annealing;
(d) subjecting the cold-rolled and annealed material to a finishing cold-rolling to thickness of 0.2±0.05 mm;
(e) tempering the finishing cold-rolled material; and
(f) processing the tempered material to the final shape.

### CROSS-REFERENCE TO RELATED APPLICATIONS

This application is based upon and claims the benefit of priority from Korean Patent Applications No. 10-2011-0062522, filed on Jun. 27, 2011, the entire content of which is incorporated herein by reference.

### TECHNICAL FIELD

The present disclosure relates to a bottom chassis for a tablet type mobile display such as tablet PC and a method for manufacturing thereof, and more particularly relates to the bottom chassis for a tablet type mobile display which can contribute to lighten weight of the bottom chassis for a mobile display by controlling over the alloy composition and process condition, and the method for manufacturing thereof.

### BACKGROUND

A liquid crystal display (LCD) displays desired images on LCD device panel by controlling over the light transmittance according to the video signal which is applied to many control switches arranged in a matrix.

The LCD is usually made up of a liquid crystal panel unit, backlight unit, top chassis and bottom chassis.

The liquid crystal panel unit containing the liquid crystal (LC) displays planar images by controlling over a surface light irradiated from the backlight unit.

The backlight unit containing the light source irradiates the surface light to the liquid crystal panel unit. In the past, a CCFL (Cold Cathode Fluorescent Lamp) was mainly used as the light source, but the light source is recently being converted to a LED (Light Emitting Diode) having advantages such as low power and long life span.

The bottom chassis encases the backlight unit and releases the heat generated from the light source, so that it is required to have an excellent strength and formability.

The top chassis anchors the liquid crystal panel unit at the backlight unit in order to prevent the detachment of the liquid crystal panel unit.

The LCD is being applied to a tablet type mobile display such as tablet PC as well as a fixed type display.

On the other hand, it is required that the bottom chassis applied to the tablet type mobile display should be ultra-thin and light weight to be used to mobile devices as well as it must have properties such as the excellent strength and formability. The bottom chassis for a mobile display now being produced has the maximum thickness of 0.3 T (0.3 mm) class according to the material and the process condition.

Of course, the ultra-thin bottom chassis under a thickness of 0.3 T class would be preferred, considering the trend that the mobile display is being thinner and lighter. However, there has been a problem that the bottom chassis having a thickness less than 0.3 T class does not have sufficient mechanical properties such as strength.

### SUMMARY

The present disclosure provides some embodiments of an aluminum-based bottom chassis for a tablet type mobile display which can attain both mechanical properties such as strength and ultra-thin (thickness of 0.2 T class) by controlling over the alloy composition and process condition, and a method for manufacturing thereof.

According to one embodiment of the present disclosure, provided is a bottom chassis for a tablet type mobile display comprising a panel unit having a touch inputting unit and a planar image display unit, and a backlight unit irradiating a surface light to the panel unit, wherein said bottom chassis encases the backlight unit, comprises an aluminum alloy having the following chemical composition:

at most 0.3 wt % silicone (Si);

at most 0.4 wt % iron (Fe);

at most 0.1 wt % copper (Cu);

0.15-0.2 wt % manganese (Mn);

0.15-3.5 wt % magnesium (Mg);

0.15˜0.35 wt % chromium (Cr); and

at most 0.1 wt % zinc (Zn) with the balance being unavoidable impurities and aluminum (Al), and has a thickness of 0.2±0.05 mm.

According to another embodiment of the present disclosure, provided is a method for manufacturing the bottom chassis comprises the following steps of: (a) homogenizing a slab material by heating, wherein the slab material has the following chemical composition: at most 0.3 wt % silicone (Si), at most 0.4 wt % iron (Fe), at most 0.1 wt % copper (Cu), 0.15˜0.2 wt % manganese (Mn), 2.5˜3.5 wt % magnesium (Mg), 0.15˜0.35 wt % chromium (Cr), and at most 0.1 wt % zinc (Zn) with the balance being unavoidable impurities and aluminum (Al);

(b) subjecting the homogenized material to a hot rolling to a thickness of 7.5±0.5 mm followed by cooling;

(c) subjecting the hot rolled and cooled material to a 1^{st} cold rolling to a thickness of 2.5±0.5 mm followed by annealing;

(d) subjecting the cold rolled and annealed material to a finishing cold rolling to a thickness of 0.2±0.05 mm;

(e) tempering the finishing cold rolled material; and

(f) processing the tempered material to the final shape.

### BRIEF DESCRIPTION OF THE DRAWINGS

FIG. 1 is an exploded perspective view of an example of a tablet type mobile display comprising the bottom chassis of the present invention.

FIG. 2 is a flow chart for a process for manufacturing the bottom chassis of the present invention for a tablet type mobile display.

### DETAILED DESCRIPTION

Feature of the invention and methods of accomplishing the same may be understood more readily by reference to the following detailed description of exemplary embodiments and the accompanying drawings. The invention may, however, be embodied in many different forms and should not be construed as being limited to the embodiments set forth herein. Rather, these embodiments are provided so that this disclosure will be thorough and complete and will fully convey the concept of the invention to those skilled in the art, and the invention will only be defined by the appended claims.

Hereinafter, the bottom chassis for a tablet type mobile display according to the present invention and the method for manufacturing thereof will be described in detail.

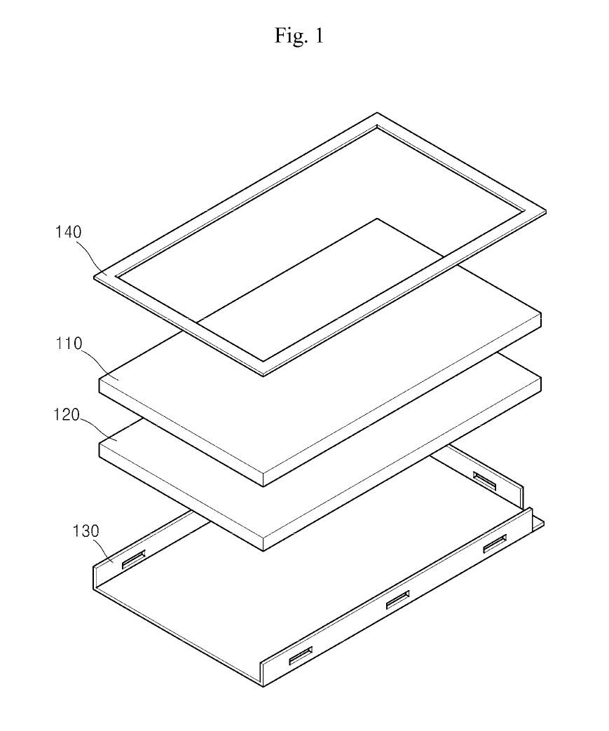

FIG. 1 is an exploded perspective view of an example of a tablet type mobile display comprising the bottom chassis of the present invention.

Referring to FIG. 1, the tablet type mobile display comprises a panel unit 110 and a backlight unit 120.

The panel unit 110 includes a planar image display unit which displays a planar image using a light irradiated from the backlight unit 120, and a touch inputting unit wherein a signal is entered thereto from a user by a pen or finger.

The backlight unit 120 may comprise various optical sheets such as a light guide plate and a diffusion plate to irradiate a uniform surface light to a backside of the panel unit 110.

The backlight unit 120 is divided into an edge type and a direct type according to the position of the light source. The direct type unit has a light source and reflection plate at the bottom side of the backlight unit to irradiate the surface light to the liquid crystal panel unit, while the edge type unit has a light source at the edge of the backlight unit to irradiate the surface light to the panel unit by using a light guide plate.

Referring to the entire structure of the mobile display, the light source is arranged at the bottom side of the mobile display in the direct backlight unit, and at the lateral side of the mobile display in the edge type backlight unit, respectively. In the point of slimming of the mobile display, the edge type backlight unit wherein the light source is arranged at the lateral side of the planar image display unit is more preferable.

The tablet type mobile display further comprises a bottom chassis 130 and a top chassis 140 in addition to the panel unit and backlight unit.

The bottom chassis 130 encases the backlight unit 120, and protects the panel unit 110 and backlight unit 120 from the external impact. Further, the bottom chassis 130 releases a heat generated from the light source of the backlight unit 120 to the outside, and plays a role of a ground by being electrically connected to the light source of the backlight unit 120 and other internal circuits.

In the tablet type mobile display, the bottom chassis 130 highly affects to the entire thickness and weight of the display. In the present invention, an aluminum alloy is used to enhance properties of the bottom chassis 130. The aluminum alloy is favorable for reducing weight and has excellent thermal conductibility and light reflectance.

The top chassis 140 fix the panel unit 110 to prevent from separation, and protects the panel unit 110 and backlight unit 120 from external impact like the bottom chassis 130.

The shape of the bottom chassis 130 and top chassis 140 is not limited to the example illustrated at FIG. 1.

Hereinafter, the bottom chassis for a tablet type mobile display according to the present invention and the method for preparing thereof will be described.

Bottom Chassis

The bottom chassis of the present invention for a tablet type mobile display comprises at most 0.3 wt % silicone (Si), at most 0.4 wt % iron (Fe), at most 0.1 wt % copper (Cu), 0.15˜0.2 wt % manganese (Mn), 2.5˜3.5 wt % magnesium (Mg), 0.15˜0.35 wt % chromium (Cr) and at most 0.1 wt % zinc (Zn).

The bottom chassis is balanced with aluminum (Al) and impurities unavoidably being included during the casting process.

Silicone (Si)

Silicone enhances the strength without deteriorating the corrosion resistance when it is added in a small amount. It is desired that the silicone is employed in an amount of at most 0.3 wt % based on the total weight of the aluminum alloy of the present invention. If the silicone content exceeds 0.3 wt %, the corrosion resistance may be rapidly decreased.

Iron (Fe)

Iron enhances the strength by inhibiting the decline of the electric conductivity of the alloy and increasing the density. It is desired that the iron is employed in an amount of less than 0.4 wt % based on the total weight of the aluminum alloy of the present invention. If the iron content exceeds 0.4 wt %, the corrosion resistance may be decreased.

Copper (Cu)

Copper improves the strength by hardness enhancement and precipitation hardening, and enhances the stress corrosion resistance, stress corrosion cracking resistance, fatigue resistance, corrosion resistance, corrosion fatigue resistance, and ductility at room temperature and very low temperature. It is desired that the copper is employed in an amount of less than 0.1 wt % based on the total weight of the aluminum alloy of the present invention. If the copper content exceeds 0.1 wt %, the electrical conductivity and surface characteristics may be decreased.

Manganese (Mn)

Manganese enhances the strength by solid solution strengthening effect and micro precipitation dispersion effect without worsening the corrosion resistance if it is added in small amount. It is desired that the manganese is employed in an amount of 0.15˜0.2 wt % based on the total weight of the aluminum alloy of the present invention. If the manganese content is less than 0.15 wt %, the strength enhancing effect is insufficient. However, if its content exceed 0.2 wt %, the corrosion resistance may be rapidly deteriorated.

Magnesium (Mg)

Magnesium (Mg) enhances the corrosion resistance, strength, elongation, weight reduction and machinability. It is desired that the magnesium is employed in an amount of 2.5˜3.5 wt % based on the total weight of the aluminum alloy of the present invention. If the magnesium content is less than 2.5 wt %, the addition effect is insufficient. However, if its content exceed 3.5 wt %, the formability may be deteriorated.

Chromium (Cr)

Chromium enhances properties such as grain refining effect, recrystallization temperature rising effect and stress corrosion resistance. It is desired that the chromium is employed in an amount of 0.15˜0.35 wt % based on the total weight of the aluminum alloy of the present invention. If the chromium content is less than 0.15 wt %, the addition effect is insufficient. However, if its content exceed 0.35 wt %, the electrical conductibility may be deteriorated.

Zinc (Zn)

Zinc enhances the strength by bake hardening. It is desired that the zinc is employed in an amount of at most 0.1 wt % based on the total weight of the aluminum alloy of the present invention. If the zinc content exceeds 0.1 wt %, the weldability, extrusion processability and corrosion resistance may be deteriorated.

The bottom chassis of the present invention comprising the aluminum alloy prepared in accordance with the above composition and following process condition may have a thickness of 0.2 mm, and 0.2±0.05 mm in consideration of error.

The prepared bottom chassis shows high strength with a tensile strength of at least 240˜285 N/mm² and high hardness with a brinell hardness of at least 80. Further, it shows a yield strength of at least 150˜285 N/mm² and elongation of at least 5%.

Process for Preparing the Bottom Chassis

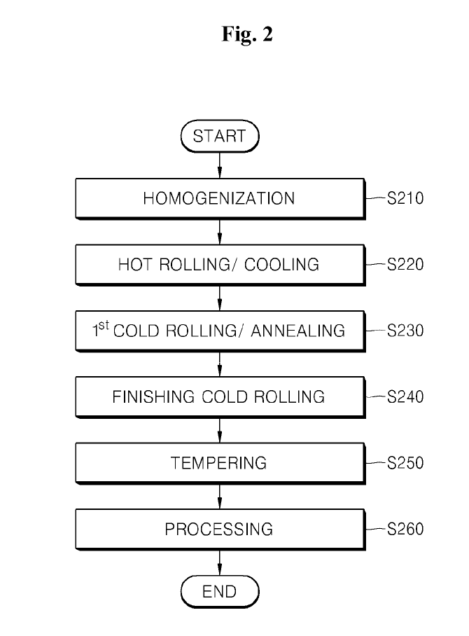

FIG. 2 is a flow chart for a process for manufacturing the bottom chassis of the present invention for a tablet type mobile display.

Referring to FIG. 2, the illustrated process for preparing the bottom chassis comprises the following steps: homogenizing step (S210), hot rolling/cooling step (S220), 1^{st} cold rolling/annealing step (S230), finishing cold rolling step (S240), tempering step (S250), and processing step (S260).

Homogenization

In this homogenizing step (S210), the slab material comprising at most 0.3 wt % silicone (Si), at most 0.4 wt % iron (Fe), at most 0.1 wt % copper (Cu), 0.15˜0.2 wt % manganese (Mn), 2.5˜3.5 wt % magnesium (Mg), 0.15˜0.35 wt % chromium (Cr) and at most 0.1 wt % zinc (Zn) with the balance being unavoidable impurities and aluminum (Al) is homogenized by heating.

The slab material as a semi-finished product may be prepared by casting and have a thickness of about 520 mm.

Preferably, the homogenization may be conducted at 530˜560° C. for 24˜48 hours. If the temperature is lower than 530° C. or the time is shorter than 24 hours, the homogenization may be insufficient. On the other hand, if the temperature is higher than 560° C. or the time is longer than 48 hours, the strength may be decreased by grain coarsening as well as the productivity is declined.

Hot Rolling/Cooling

In this hot rolling/cooling step (S220), the homogenized material is hot rolled to a thickness of 7.5±0.5 mm. The final bottom chassis is hard to be slimmed to a thickness of 0.2 mm class if the thickness of the rolled material exceeds 8.0 mm, but the surface roughness may increased if the thickness of the rolled material is less than 7 mm. After the hot rolling, the resulting material is subjected to a forced cooling to a temperature of 250˜400° C., and then preferably air cooled. The forced cooling temperature can be a coiling temperature if the material is coiled.

It is preferred that the forced cooling is performed to 250˜400° C. at about 5˜50° C./sec cooling rate. If the termination temperature of the forced cooling exceeds 400° C., the surface is oxidized. On the other hand, the toughness of the prepared bottom chassis may be reduced if the temperature is less than 250° C.

1^{st} Cold Rolling/Annealing

In this 1^{st} cold rolling/annealing step (S230), the hot rolled material is subjected to the 1^{st} cold rolling to a thickness of 2.5±0.5 mm and then annealed.

The 1^{st} cold rolling is conducted at a high reduction ratio of about 66.7% to obtain the cold rolled material with a thickness of 2.5±0.5 mm. The final bottom chassis is hard to be slimmed to a thickness of 0.2 mm class if the material is thicker than 3.0 mm, and the desired elongation may not be obtained if the material is thinner than 2.0 mm.

The surface hardness of the material may be increased by several effects such as rolling process hardening effect obtained through the above 1^{st} cold rolling step (S230) and following finishing cold rolling step (S240)

The annealing after the 1^{st} cold rolling is carried out to obtain the ductibility of the bottom chassis: The reduction of the ductibility may be caused by increasing or maintaining the hardness or strength of the processed material through the cold rolling to a certain level. Therefore, the desired strength may be obtained without reducing the ductibility if the annealing is conducted after the 1^{st} cold rolling.

In this step, it is desired that the annealing is conducted in a furnace at a temperature of 300˜400° C. If the temperature exceeds 400° C., the strength may be decreased, and if the temperature is less than 300° C., it is not enough to obtain the desired elongation.

After annealing, a cooling in furnace may be performed. If much plastic deformation is caused by the 1^{st} cold rolling at once, freezefracture and excessive increase of the hardness may occur, so that it is difficult to obtain a suitable elongation. As a result of the cooling in furnace, the above problems may be solved by removing the stress.

Finishing Cold Rolling

In this finishing cold rolling step (S240), the rolled and annealed material is subjected to a finishing cold rolling to a thickness of 0.2±0.05 mm.

In this step, the material is manufactured to the desired thickness of 0.2 mm class. Further, the hardness of the material may be enhanced by the work hardening effect caused by the finishing cold rolling.

Tempering

In this tempering step (S250), the rolled material prepared in the above step is tempered to control the hardness and elongation, and the tempering is preferably conducted at a temperature ranging from 350 to 370° C. If the tempering is carried out at the temperature below 350° C., the result may be insufficient, and if the tempering is conducted at a temperature over 370° C., the strength may be decreased.

After the tempering, it is preferred that the resulting material is slowly cooled at most 5° C./sec to prevent lowering the elongation.

Further, a tension leveling may further conducted to the tempered material as described above. In this case, the stress caused by the finishing cold rolling may be removed and the desired tension strength may be obtained.

Processing

In this processing step (S260), the tempered material is finally processed to the desired shape of the bottom chassis.

The following Examples are intended to further illustrate the present invention without limiting its scope.

### Example

### 1. Preparation of an Aluminum Alloy Sample

Aluminum alloy samples (Examples 1 to 3 and Comparative Examples 1 to 3) having the following composition showed on Table 1 were prepared as follows:

TABLE 1
(unit: wt %)

| | | Si | Fe | Cu | Mn | Mg | Cr | Zn |
|---|---|---|---|---|---|---|---|---|
| Example | 1 | 0.3 | 0.4 | 0.1 | 0.2 | 3.0 | 0.25 | 0.1 |
| | 2 | 0.3 | 0.4 | 0.1 | 0.2 | 2.5 | 0.35 | 0.1 |
| | 3 | 0.3 | 0.4 | 0.1 | 0.2 | 3.5 | 0.15 | 0.1 |
| Comparative | 1 | 0.25 | 0.4 | 0.1 | 0.1 | 2.5 | 0.25 | 0.1 |
| Example | 2 | 0.25 | 0.4 | 0.1 | 0.1 | 2.2 | 0.25 | 0.1 |
| | 3 | 0.25 | 0.4 | 0.1 | 0.1 | 2.8 | 0.25 | 0.1 |

In order to prepare the samples of Examples 1 to 3, each slab (thickness: 520 mm) was homogenized at 540° C. for 36 hours, hot rolled to a thickness of 7.5 mm, cooled to 300° C. at 10° C./sec, and air cooled to a room temperature. The resulting sample was subjected to the 1^{st} cold rolling to a thickness of 2.5 mm, annealed at 400° C. for 6 hours, and cooled in furnace for 6 hours. Then, the sample was subjected to a finishing cold rolling to a thickness of 0.2 mm, tempered at 360° C. for 6 hours, and air cooled.

Whereas, in order to prepare the samples of Comparative Examples 1 to 3, each slab (thickness: 520 mm) was homogenized at 540° C. for 36 hours, hot rolled to a thickness of 6 mm, cooled to 300° C. at 10° C./sec, and air cooled to a room temperature. The resulting sample was sequentially subjected to a cold rolling to a thickness of 3.5 mm, 2.0 mm, 0.8 mm and 0.3 mm. Then, the rolled sample was annealed at 320° C. for 3 hours, and air cooled.

### 2. Mechanical Property

Table 2 shows mechanical properties of the aluminum ally samples prepared in accordance with Examples 1 to 3 and Comparative Examples 1 to 3.

TABLE 2

| | | Tensile | Yield | | |
|---|---|---|---|---|---|
| | | strength | strength | Elongation | Brinell |
| | | (N/mm²) | (N/mm²) | (%) | hardness |
| Example | 1 | 260 | 155 | 8 | 83 |
| | 2 | 255 | 162 | 9 | 84 |
| | 3 | 263 | 151 | 8 | 85 |
| Comparative | 1 | 234 | 158 | 6 | 71 |
| Example | 2 | 245 | 163 | 5 | 78 |
| | 3 | 257 | 165 | 5 | 77 |

As shown in Table 2, the samples (thickness: 0.2 mm) of Examples 1 to 3 according to the present invention which are thinner than those of Comparative Examples 1 to 3, have equal or better strength and elongation than those of Comparative Examples 1 to 3.

Therefore, the bottom chassis prepared according to the present invention is very effective to make a light-weight bottom chassis for a tablet type mobile display.

The bottom chassis manufactured according to the present invention having a thickness of about 0.2 mm class shows a strength of at least 240 N/mm² and brinell hardness of at least 80.

Therefore, the bottom chassis of the present invention which is light-weight and has excellent mechanical properties can be applied to a bottom chassis for a tablet type mobile display.

While certain embodiments have been described, these embodiments have been presented by way of example only, and are not intended to limit the scope of the disclosures. Indeed, the novel methods and apparatuses described herein may be embodied in a variety of other forms; furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A bottom chassis for a tablet type mobile display comprising a panel unit having a touch inputting unit and a planar image display unit, and a backlight unit irradiating a surface light to the panel unit, wherein said bottom chassis encases the backlight unit, comprises an aluminum alloy having the following chemical composition:
at most 0.3 wt % silicone (Si);
at most 0.4 wt % iron (Fe);
at most 0.1 wt % copper (Cu);
0.15˜0.2 wt % manganese (Mn);
2.5˜3.5 wt % magnesium (Mg);
0.15˜0.35 wt % chromium (Cr); and
at most 0.1 wt % zinc (Zn) with the balance being unavoidable impurities and aluminum (Al), and has a thickness of 0.2±0.05 mm.

2. The bottom chassis of claim 1, wherein the bottom chassis has a tensile strength of at least 240 N/mm² and brinell hardness of at least 80.

3. The bottom chassis of claim 2, wherein the bottom chassis has a yield strength of at least 150 N/mm² and elongation of at least 5%.

4. A method for manufacturing the bottom chassis for a tablet type mobile display, which comprises the following steps of:
(a) homogenizing a slab material by heating, wherein the slab material has the following chemical composition: at most 0.3 wt % silicone (Si), at most 0.4 wt % iron (Fe), at most 0.1 wt % copper (Cu), 0.15˜0.2 wt % manganese (Mn), 2.5˜3.5 wt % magnesium (Mg), 0.15˜0.35 wt % chromium (Cr), and at most 0.1 wt % zinc (Zn) with the balance being unavoidable impurities and aluminum (Al);
(b) subjecting the homogenized material to a hot rolling to a thickness of 7.5±0.5 mm followed by cooling;
(c) subjecting the hot rolled and cooled material to a 1^{st} cold rolling to a thickness of 2.5±0.5 mm followed by annealing;
(d) subjecting the cold rolled and annealed material to a finishing cold rolling to a thickness of 0.2±0.05 mm;
(e) tempering the finishing cold rolled material; and
(f) processing the tempered material to the final shape.

5. The method of claim 4, wherein the homogenization in step (a) is conducted at a temperature ranging from 530 to 560° C. for 24 to 48 hours.

6. The method of claim 4, wherein the cooling in step (b) is conducted by the forced cooling to a temperature ranging from 250 to 400° C. followed by air cooling.

7. The method of claim 4, wherein the annealing in step (c) is conducted at a temperature ranging from 300 to 400° C.

8. The method of claim 7, which further comprises a step of subjecting the annealed material in step (c) to a cooling in furnace where the annealing is conducted.

9. The method of claim 4, wherein the tempering in step (e) is conducted at 350˜370° C.

10. The method of claim 9, which further comprises a step of subjecting the tempered material in step (e) to a slow cooling at a rate of at most 5° C./sec.

11. The method of claim 4, which further comprises a step of subjecting the tempered material in step (e) to a tension leveling.
